(19) United States
(12) Patent Application Publication
(10) Pub. No.: US 2022/0311505 A1
(43) Pub. Date: Sep. 29, 2022

(54) A FLEET OF HIGH ALTITUDE PLATFORMS COMPRISING ANTENNAS AND METHOD OF POSITIONING THEREFOR

(71) Applicant: Stratospheric Platforms Limited, Douglas (IM)

(72) Inventors: Peter Davidson, Douglas (IM); David Grace, York (GB); Andrew Faulkner, Cambridge (GB)

(21) Appl. No.: 17/616,148

(22) PCT Filed: Jun. 19, 2020
(86) PCT No.: PCT/GB2020/051482

§ 371 Date: Dec. 2, 2021

(30) Foreign Application Priority Data
Jun. 20, 2019 (GB) 1908828.5

(51) Int. Cl. H04B 7/185

(52) U.S. Cl. CPC H04B 7/18504

(57) ABSTRACT

A fleet of high altitude platforms (HAPs) arranged to provide information services to a service area, each SHHAP comprising at least one phased array antenna and in communication with a telecommunications backhaul system, the service area comprising at least 100,000 items of user equipment (UE), and wherein the service area comprises a non-uniform data requirement distribution, comprising areas of both higher and lower data rate requirements, and wherein the SHHAPs are positioned with a non-uniform spacing such that the SHHAPs are positioned closer together over areas of higher data rate requirements than over areas of lower data rate requirements.

### TECHNICAL FIELD

The present invention relates to a fleet of station-holding high altitude platforms (HAPs), each station-holding HAP (SHHAP) comprising at least one phased array antenna and in communication with a telecommunication backhaul system and a method for positioning the members of the fleet.

### BACKGROUND AND PRIOR ART

High altitude platforms (aircraft and lighter than air structures situated from 10 to 35 km altitude) have been proposed to support a wide variety of applications. Areas of growing interest are for telecommunications, positioning, observation and other information services, and specifically the provision of high speed Internet, e-mail, telephony, televisual services, games, video on demand, mapping services and global positioning.

High altitude platforms possess several advantages over satellites as a result of operating much closer to the earth's surface, at typically around 20 km altitude. Geostationary satellites are situated at around 40,000 km altitude, and low earth orbit satellites are usually at around 600 km to 3000 km altitude. Satellites exist at lower altitudes but their lifetime is very limited with consequent economic impact.

The relative nearness of high altitude platforms compared to satellites results in a much shorter time for signals to be transmitted from a source and for a reply to be received (the “latency” of the system). Moreover, SHHAPs are within the transmission range for standard mobile phones for signal power and signal latency. Any satellite is out of range for a normal terrestrial mobile phone network, operating without especially large antennas.

HAPs also avoid the rocket propelled launches needed for satellites, with their high acceleration and vibration, as well as high launch failure rates with their attendant impact on satellite cost.

Payloads on SHHAPs can be recovered easily and at modest cost compared to satellite payloads. Shorter development times and lower costs result from less demanding testing requirements.

U.S. Pat. No. 7,046,934 discloses a high-altitude balloon for delivering information services in conjunction with a satellite.

US 20040118969 A1, WO 2005084156 A2, U.S. Pat. No. 5,518,205 A, US 2014/0252156 A1, disclose particular designs of high altitude aircraft.

However, there are numerous and significant technical challenges to providing reliable information services from HAPs. Reliability, coverage and data capacity per unit ground area are critical performance criteria for mobile phone, device communication systems, earth observation and positioning services.

Government regulators usually define the frequencies and bandwidth for use by systems transmitting electromagnetic radiation. The shorter the wavelength, the greater the data rates possible for a given fractional bandwidth, but the greater the attenuation through obstructions such as rain or walls, and more limited diffraction which can be used to provide good coverage. These constraints result in the choice of carrier frequencies of between 0.7 and 5 GHz in most parts of the world with typically a 10 to 200 MHz bandwidth.

There is a demand for high data rates per unit ground area, which is rapidly increasing from the current levels of the order 1-100 Mbps/square kilometre.

The issue of organisation of fleets of high altitude platforms have been considered from the perspectives of organising the HAPs so that continuous coverage is provided and handover from one HAP to another.

K. Katzis, D. Grace, Inter-high-altitude-platform handoff for communications systems with directional antennas, (Invited Paper) URSI Radio Science Bulletin, March 2010 https://ieeexplore.ieee.org/document/7911046 is primarily concerned with handoff from one aircraft to another for fixed and steerable antennas that are used on the ground stations.

U.S. Pat. No. 9,093,754B2 is concerned with changing the separation of reflector and emitter according to balloon altitude.

EP2803149A1, relates to a balloon network with free-space optical communication between super-node balloons and RF communication between super-node and sub-node balloons.

US20180069619A1 is concerned with avoiding coverage gaps based on the increase in the horizontal distance between a first high altitude platform and a second high altitude platform, identifying a gap in the contiguous ground coverage area between the first high altitude platform and the second high altitude platform; in response to identifying the gap in the contiguous ground coverage area between the first high altitude platform and the second high altitude platform, causing a communication system of the first high altitude platform to transmit a wider ground-facing communication beam in order to cover the identified gap in the contiguous ground coverage area.

AU763009B2 discloses free floating balloons capable of handoff.

U.S. Ser. No. 10/177,985B2 satisfies the provision of network flows.

D. Grace, J. Thornton, G. Chen, G. P. White, T. C. Tozer. Improving the system capacity of broadband services using multiple high-altitude platforms, IEEE Trans. Wirel. Commun. 2005, 4, 700-709, https://ieeexplore.ieee.org/abstract/document/1413236 discloses SHHAPs providing a regular hexagonal pattern of cells.

For a system communicating to ground based mobile phones or user equipment, there is benefit in using existing mobile frequencies (typically above 0.6 GHz to 4 GHz-50 cm to 7.5 cm wavelength-λ), rather than the mm wavelengths referred to in the paper by Grace et. al., due to their relatively low absorption and better penetration through walls and other objects. Higher frequencies up to 90 GHz (3 mm wavelength) can also be utilised if there is a clear line of sight.

Focus to date has been on maximising the usable coverage area from a HAP, so as to reduce the amount of infrastructure required to provide a limited service. This has resulted in HAP coverage areas with radii of 30 km or greater being proposed in the literature.

David Grace and Mihael Mohorcic, Broadband Communications via High Altitude Platforms, John Wiley and Sons, Hardcover 398 pages, ISBN: 978-0-470-69445-9, Oct. 2010 teaches that uniform spacing of such fleets of HAPs is one unique advantage over terrestrial wireless communications deployments, which are required to use uneven cell spacings. Thus, HAPs fleet layouts have largely to date been designed based on a regular tessellation, except where adjustments are required for areas where no coverage is desired or mandated, for example due to the need to limit interference or very limited items of user equipment (UE) being present.

Moreover, focus has included methods to obtain uniform cell areas across a HAP coverage area by use of specialist antennas, as shown in J. Thornton, D. Grace, M. H. Capstick, T. C. Tozer., Optimising an Array of Antennas for Cellular Coverage from a High Altitude Platform, IEEE Trans.Wireless Commun, 2 (3) 2003, pp. 484-492, https://ieeexplore.ieee.org/abstract/document/1198098, rather than minimising cell area where possible, as used in the present invention.

Ground based mobile phone mast positioning has long recognised that mast coverage densities depend on the local population densities: high population densities or major roads or railways require small distances between masts.

Previously whilst the impact of changes in data density rate have been considered within the coverage area of an individual high altitude platform, the impact of these data density rates on optimal positions of individual members of a fleet of HAPS had not been considered where individual members could hold approximate station. As a result, fleets of HAPS over large areas have been shown to have uniform spacing notwithstanding substantial differences in population density distribution within the area covered.

For a data rate provision provided from a high altitude platform system, it has therefore been assumed that a uniform distribution of HAPs over a service area, even when the data requirement over the service area is non-uniform, is the most sensible arrangement.

Improvements in this area would therefore be highly desirable.

### DETAILED DESCRIPTION OF THE INVENTION

The data rate per unit ground area between a horizontally oriented phased array antenna mounted on a SHHAP and UE's located at ground level, has been identified to be a strong function of the angle θ of a line drawn between a UE located at ground level and the SHHAP, and the vertical. It has been discovered that the consequence of this is that providing a fleet of SHHAPs with a uniform distribution over a service area that has a non-uniform data requirement would be highly inefficient in terms of data provision rate for the service area and maximising the utility of the data rate that each SHHAP can provide.

Thus, in a first aspect, the present invention relates to a fleet of station holding high altitude platforms (SHHAPs) arranged to provide information services to a service area, each SHHAP comprising at least one phased array antenna and in communication with a telecommunications backhaul system, the service area comprising at least 100,000 items of user equipment (UE), and wherein the service area comprises a non-uniform data requirement distribution, comprising regions of both higher and lower data rate requirements, and wherein the SHHAPs are positioned with a non-uniform spacing such that the SHHAPs are positioned closer together over regions of higher data rate requirements than over areas of lower data rate requirements.

The invention recognises the surprisingly significant challenge of providing a service to an area that includes large degrees of different demand for data transmission and reception per unit ground area for a high-altitude platform. This can be due to population density distributions, as well as the variation of usage in different areas depending on time of day.

As discussed in detail below, the knowledge of how the data rate is influenced by the position of any given UE relative to the SHHAP therefore allows optimisation of the placement of SHHAPs, to provide optimal exploitation of the capabilities of the SHHAPs in a service area containing a varying demand for data.

As such, the invention has particular utility in optimally positioning the SHHAPs when the data provision requirement varies over the service area. Thus the ratio of the highest to the lowest user equipment density arising is preferably at least 20, more preferably at least 50. In other terms, the user equipment densities vary in the service area over at least the range of from 20 to 1000 UE per km², preferably from 10 to 1500 UE per km², more preferably 5 to 2000 UE per km², or a still greater variation.

The present invention thus allows the efficient provision of information services at very different capacities with different population densities, topographies, ground-based infrastructure, existing and planned mobile phone towers, disasters, urban commuting, entertainment events and so forth.

In general, the fleet will be able to provide a data rate service to at least 90% of the surface area of the service area, more preferably at least 95% and ideally close to 100% and ensuring that there are only small gaps in the service provided.

The fleet of SHHAPs is intended to cover a service area that extends over a significant population. The service area may therefore comprise greater than 200,000, more preferably greater than 500,000, more preferably greater than 1 million items of UE.

The service area may therefore be greater than 10,000 km², preferably greater than 50,000 km², more preferably greater than 200,000 km². A service area can be an entire political or social region, such as a country, state or province. In general the service area will therefore include a plurality of cities.

To provide an effective service over such service areas, the fleet typically comprises at least 10, more preferably at least 20, most preferably at least 40 SHHAPs.

In order to provide an efficient service area the SHHAPs preferably have an altitude of from 10,000 to 25,000 metres.

In a further preferred arrangement the SHHAPs that are located over the regions of higher data rate requirements have a lower altitude than the SHHAPs that are located over the regions of lower data rate requirements. This is because, as the SHHAPs are closer together over the regions of higher data rate requirements, the angle θ is generally smaller as between a single HAP and a given UE. Therefore, a lower altitude could provide only a small increase in theta whilst providing an increase in data rate due to the lower altitude. On the other hand, the angle θ is generally higher over regions of lower density requirements and so a reduction in altitude could result in a reduction in service provision, and so a generally higher altitude becomes optimal.

In addition, it may be desirable for the SHHAPs that are located over the regions of higher data rate requirements to have varying altitudes (e.g. by hundreds of metres). This can assist with allowing the SHHAPs to come closer together (in plan view) whilst not increasing any risk of collision.

As discussed, the present invention is particularly applicable to service areas that contain a non-uniform data requirement distribution. Preferably the regions of higher data requirement contain a higher user equipment density and the regions of lower data requirement contain a lower user equipment density, and wherein the ratio of the highest to lowest user equipment density is at least 10, more preferably at least 20 or even at least 50.

A preferred method of defining the spacing between SHHAPs is to define the lateral distance, in plan view, between a SHHAP and its nearest neighbour. Preferably the SHHAPs are positioned such that the ratio between the furthest spaced apart SHHAPs to the most closely spaced apart SHHAPs is at least 2, more preferably at least 3.

Clearly, the SHHAPs with the lowest spacing will be positioned over the regions of highest data requirement and the SHHAPs with the highest spacing will be positioned over the regions of lowest data requirement. The precise positions of the SHHAPs can be optimised, as discussed below.

As will be appreciated, the potential coverage area that each SHHAP can provide will extend over an approximately circular portion of the service area, centred directly below the location of the SHHAP. The radius of such a circular potential coverage area will be determined by a definition of a required data provision rate, below which it is considered that no useful service can be provided.

However it will be appreciated that the potential coverage areas of neighbouring SHHAPs may overlap, and in this case the coverage area will in practice be reduced, to reflect the possibility that a region within the potential coverage area can be better provided for by a neighbouring SHHAP. This may result in the coverage areas taking on a polygonal structure, despite the potential coverage areas remaining circular and overlapping.

It will also be appreciated that the size of the coverage areas will generally be smaller over the regions of higher data requirement, such that there will generally be an inverse correlation between the data requirement and the coverage area of a SHHAP over the service area.

In general, the SHHAPS are spaced apart over distances of from 1 to 100 km, although by operating the SHHAPS at differing altitudes even closer spacings can be obtained.

In regions of higher density of data demand in the service area, it is preferred that user equipment on the ground can typically “see” or receive and transmit multiple beams to and from multiple SHHAPs at discrete angles and so can resolve different SHHAPs. In its simplest form this can exploit directional antenna(s) on the user equipment. This has the consequence that both the peak data rate to and from an individual device and the amount of information that can be transmitted or received per unit area (on the ground) is increased by a factor dependent on the number of antennas on the user equipment and the number of SHHAPs in a similar fashion to a MIMO system. It should be noted that the increased data rates both to individual user equipment and expressed as data rate per unit area illuminated is not linearly related to the number of platforms visible to the platform but does increase significantly as the number of platforms increases.

In denser regions of the service area it can be advantageous to have a number of adjacent SHHAPs approximately the same distance from the user equipment. This has two positive consequences: it reduces the degree to which maximum data rates change with the position of the SHHAP in denser areas and increases the minimum distance between SHHAPs and provides for greater margin to unplanned events such as SHHAP deviation from expected course.

SHHAPs are designed to maintain station (so that a negligible horizontal displacement over time is achieved, e.g., that it can maintain ground position in the most adverse winds likely to be encountered at its operating altitude) for a high percentage of time they are providing service. For example, an aircraft will maintain its location in a position operating in a cylinder of 5 km radius, with height deviation +/−3 km about a nominal flight altitude for at least 90%, preferably 99%, more preferably 99.99% of time.

Maintaining the positions of the members of the fleet is only practically possible with SHHAPs that can hold station against the strongest winds at the operating altitude of the platform, when the aircraft or airship is a Station-Holding High Altitude Platform (SHHAP). Typically, such winds when operating at high latitudes (greater than 20 or 30 degrees from the equator) are higher in the cooler months, and lower in the hotter months. In these latitudes, wind speeds are often less than 20 m/s and indeed often less than 10 m/s in the summer months, whereas they can reach 40 m/s and occasionally 50 or even 55 m/s in the winter months, particularly at high latitudes of up to 55 degrees. Even higher peak wind speeds can be encountered nearer the winter polar vortices above 55 degrees' latitude.

In practice, aircraft that are capable of operating at high altitude, i.e., heights above 15 km, particularly heights above 17 km, and being able to hold station at high altitudes, have typical minimum cruising airspeeds of at least 20 m/s, preferably 30 m/s, and more likely 40 m/s and are capable of reaching airspeeds of 50 or 55 m/s.

To hold station, aircraft when the wind speeds are low are required to operate in an orbit, often circular. When the wind speeds are high the aircraft can maintain position by flying into the wind. If the orbit radius is small, then the aircraft has to usually operate at a significant roll angle to maintain position.

There are considerable advantages to fitting these platforms with lightweight phased arrays in a near horizontal attitude so that the axis of the array is near vertical (within 25 degrees, preferably within 10 degrees) in operation. As a result, as shown from the analysis following, the data rate per unit area reduces by a factor of close to cos⁴ θ from a maximum underneath the aircraft (where the angle of incidence is zero and therefore cos⁴θ is 1). The SHHAPs may have one or more such arrays.

Arrays inclined to the horizontal in normal operation can be fitted, but then the density distribution depends substantially on the orientation of the aircraft, unless multiple inclined arrays are used which can be shown by those skilled in the art to be less effective than a flat near horizontal array for applications involving moderate population densities.

It has been discovered that to provide economic coverage for user equipment whose use of data per unit area of ground coverage is dependent on population density, SHHAPS with approximately horizontal phased arrays can conveniently be positioned in two or three distinct patterns.

In a preferred embodiment a first arrangement of SHHAPs is provided (pattern one) for denser regions, where for at least three SHHAPs, the distances (in plan view) between SHHAPs are comparable to the operating altitude of the aircraft to within a factor of between p and q times the SHHAP altitude for communication to densely populated areas where the population density is greater than 2000 or typically 3000 people per km² in the area with p typically being greater than 0.2× and q in the range 1 to 2× the operating height of the SHHAP. Tessellation patterns of cells will depend on the array shape, radio access technology and other requirements. They could be regular or have irregularity to allow for the population and demand distribution on the ground as well as ground based infrastructure and topography.

A second pattern may be provided for less dense regions (e.g. population densities of typically greater than 25 UE per km² with occasional urban centres of up to 2000 UE per km²), where the distances (in plan view) between SHHAPs are generally much larger of typically q to r times the operating altitude of the SHHAPs, with q in the range 1 to 2× the operating height of the SHHAP and r in the range 2 to 4× the operating altitude of the SHHAPs. The pattern is generally not regular and determined by location of SHHAPs close to local small centres of higher population density as well as distance between adjacent SHHAPs to provide continuous cover at the data rate required exploiting the changes in data rate forming part of the present invention.

It may also be appropriate to create a third pattern to cover larger areas with low average population densities of less than about 20 UE per km² to the number of inhabitants and devices that require communication, with distances between SHHAPs of greater than r times the operating altitude of the SHHAPs and less than ten times the operating altitude of the SHHAPs.

It is these features that can be exploited to provide more cost efficient effective information services by SHHAPs with phased array antennas than has been previously recognised, that can efficiently position members of a fleet of SHHAPs such that the data density provided by each SHHAP more closely matches the demand for data on the ground, largely determined by population density (as typically represented by UE density) than hitherto has been foreseen.

In addition, the present invention permits further technical advantages in relation to the placement and use of ground based backhaul ground stations. Backhaul ground stations (BG stations) can provide the communication links to and from the platforms and a processing centre. Each BG station should be able to communicate independently with as many platforms in line of sight as possible, to maximize the data rate capabilities of the platforms and the BG station.

There are therefore at least as many beams formed at each BG station as platforms visible from the individual BG stations. Using phased arrays as the communication system at the BG stations can provide this facility. The design of these phased arrays can be similar to those on the platforms.

To reduce the number of BG stations and their associated costs, it is useful for the BG stations to have multi-beaming capability so that they can each communicate with each aerial antenna independently when there is a group of multiple antennas, to provide the high data rates required for the network. By this means the data rate to or from each BG station can be increased by a factor equal to the number of aircraft in or near line of sight over that which would be possible with a single aircraft in line of sight.

The data flow to and from the BG stations which are connected to a particular SHHAP must be equal to the data flow from and to the SHHAP provided by the Fronthaul antenna(s). This means for example that if the Fronthaul arrangements provide 600 beams of 100 MHz bandwidth with 2.5 bps/Hz, with two polarisations, so a total SHHAP capacity of 600×100×2.5×2=300 Gbps, and the backhaul arrangements have 500 MHz bandwidth, two polarisations and 5 Bps/Hz, so a capacity of 5 GBps per beam, then the SHHAP will need 60 backhaul beams or to be in line of sight with 60 BG stations for the data flow requirements into and out of the SHHAP to be satisfied.

If the BG station antennas use phased array antennas, they can provide beams to however many SHHAPs are in line of sight if the BG station antennas have suitable angular resolution to resolve the SHHAPS. So if BG station antennas are located appropriately—informed by the position of the SHHAPs according to the invention—it can be arranged for in areas of high data demand, where the SHHAPs are relatively close together, the associated BG stations can resolve many SHHAPs and the number of BG stations required to service the fleet of SHHAPs can be dramatically reduced. If in the example above each BG station saw 5 SHHAPS rather than say 2 SHHAPs then for a fleet of 10 SHHAPS the number of BG stations would be reduced from 10 SHHAPs×60 beams/SHHAP/2 to 10 SHHAPs×60 beams/SHHAP/5 or From 300 BG stations to 120 BG stations with a very significant economic benefit.

Therefore, in a second aspect, the invention relates to a system for providing information services to a service area, the system comprising a fleet of SHHAPs as described herein, in combination with a backhaul ground station arrangement, wherein the BG stations are positioned with a non-uniform spacing such that the BG stations are positioned closer together in regions of higher data rate requirements than in areas of lower data rate requirements.

In areas of low data demand the spacing of the SHHAPs will be greater and BG stations are unlikely to be able to resolve as many SHHAPs but in these areas the backhaul requirements may be lower per SHHAP and so the number of backhaul beams per SHHAP will be less and the relative cost of BG stations per SHHAP will be lower.

As is shown in the discussion below, the data rate per unit area, with a constant data rate per beam, will be approximately inversely proportional to the minimum beam area and therefore proportional to 1/cos⁴θ, where, as described earlier, θ is the angle between the beam and the vertical.

As discussed, this surprising finding has profound implications for how to optimally position members of a fleet of SHHAPs to maximise data provision over a service area which contains a varying UE density.

Thus, in a third aspect, the invention relates to a method of positioning members of a fleet of high altitude platforms (HAPs) to provide information services to a service area, each SHHAP comprising at least one phased array antenna and in communication with a telecommunications backhaul system, the service area comprising at least 100,000 items of user equipment (UE), and wherein the service area comprises a non-uniform data requirement distribution, comprising regions of both higher and lower data rate requirements, and wherein the method employs a first step of performing an optimising data provision rate calculation involving the parameter cos⁴θ or an approximately equivalent function, where θ is the angle defined earlier to provide a data service rate to each UE, followed by a second step of positioning the members of the fleet according to the results of the optimising calculation.

One significant advantage of the present invention is the ability to adapt and change the positions of the SHHAPs as the density of the UEs on the ground changes with time. This could be particularly useful in situations such as diurnal variation or periodic events due to commuting, or infrequent ad hoc events such as sports events or entertainment events. The method of the present invention can adapt in real time to changes in the density in the service area.

The present invention can also be employed in scenarios where a SHHAP becomes non-functional. In this case, a previously optimal pattern would become sub-optimal and the method could be employed to rearrange the reduced number of SHHAPs to maintain an optimal state until additional functional SHHAPs could be added to the fleet, as desired.

In a fourth aspect, the invention provides a computer program comprising computer implementable instructions which when implemented on a computer causes the computer to perform a method as described herein.

Phased Array Antennas for Fronthaul

Antenna(s) mounted on SHHAPS can communicate both to and from UE, here referred to as fronthaul, not primarily connected other than via the SHHAP antenna(s) with a large ground based communication network such as the internet or a cellular network. Such antenna(s) can also communicate with backhaul ground based stations (“BG stations”) which are directly connected to a large ground based communication network and provide “backhaul” known to those skilled in the art.

Although the signals from each antenna element are available for any usage, it is practical to apply a different set of delays across the array, sum the second set of signals and form a second beam. This process can be repeated many times to form many different beams concurrently using the array.

Forming many beams in the digital domain can be readily achieved. The only requirement after digitization is additional processing resources and data bandwidth to communicate or further process all the beam information.

While it is possible to form a large number of beams with an individual phased array, the maximum number of “independent” beams that can carry data unique from all other beams cannot exceed the total number of antenna elements in the array. For example, if an array has 300 independent antenna elements (separated by −λ/2 or greater) there can be a maximum of 300 independent beams, each of which can be used to form a cell; more beams than this can be formed but these beams will not be independent. In practice this lack of independence will give rise to mutual interference between the beams. These non-independent beams may still be utilised by appropriate resource sharing schemes or in other ways relevant to the invention.

Phased arrays can form well defined beams over a scan angle range up to approximately ±75° from the axis normal to the plane of the array. This is due to the geometrical limitation of the array where the illumination area of the elements is reduced due to the scan angle; also the sensitivity of the beam of the individual antenna elements is reduced due to their being off the centre of the beam. The result is that the illumination area from a SHHAP with a horizontal array is limited by the maximum scan angle to approximately 90 km diameter with large single arrays for transmit and receive.

The platforms are usually equipped for Fronthaul with one, two or more phased arrays of sometimes equivalent size and number of elements but sometimes different if using very different frequencies (for example 2 GHz and 3.5 GHz). Where two arrays are used for Fronthaul, there will typically be a transmit array and a receive array, to enable the system to have concurrent transmission and reception for any encoding. It is possible to use a single array, but the electronics required is of greater complexity and weight. The arrays form beams that divide the service area into a number of patches. The patches are treated as “cells” by the cellular telephone network.

Depending on the embodiment of the array system, a position detection system can be used with a control and coefficient processor interfacing with a signal processing system in turn linked to a clock system which can be interfaced in turn to a positioning system.

Beam polarisation can be used to increase data rates.

Beamforming

The user equipment may comprise phased array antennas to generate spatially resolved narrow beams to SHHAPs or constellations of SHHAPs.

The minimum size of the area on the ground, the “resolution area,” which an independent beam from a single aerial antenna could interact with, varies with its position relative to the aerial antenna. The “maximum beam data rate” (MBDR) that can be transferred to or from a single antenna within a beam is given by the number of bits per second per Hertz bandwidth, multiplied by the bandwidth available. The maximum number of bits per second per Hertz is limited by the signal to noise ratio of the signal, as is well known to those skilled in the art.

High Altitude Platforms High altitude platforms can be implemented as:

(i) Aircraft that are powered using either solar energy or hydrogen or hydrocarbon fuel to carry the communications equipment at approximately 20 km (65,000 feet). The aircraft carry the equipment for communicating with UEs and with Backhaul Ground stations (BG stations). Also, they carry the signal processing systems, clock recovery and timing units and control computers. Preferred aircraft comprise a fuselage, wings, a tail and a form of propulsion.

(ii) Free flying aerostats powered by solar cells or other technologies. The aerostats carry the equipment for communicating with UEs and with the BG stations. Also, they carry the signal processing systems, clock recovery and timing units and control computers.

(iii) Tethered aerostats powered by hydrogen conveyed along the tether, or supplied with electrical power via the tether or supplied by solar cells situated on or connected to the aerostat platforms. A tethered aerostat supporting one or more tethers can carry a number of platforms at a number of different altitudes with each platform in turn supported by the tether(s). Each platform may also receive additional support from its own aerostat. The tethered platform system carries the equipment for communicating with UEs and with the BG stations, and they may carry the signal processing systems, precise clock and timing units and control computers or this may be ground based.

The system may consist of one or several types of platform described above.

Processing System

The positioning of the members of the fleet of SHHAPs may be managed by a processing system, which may be a distributed system or ground based, saving weight and power on the aerial platforms. The processing system can interface with a cellular telephone network, and it provides direct control of the signals being used by the platforms to communicate with the UEs.

The processing system may be physically distributed between a processing centre, processing co-located with the aerial antennas and/or backhaul ground stations, and processing services provided by third-party (known as “cloud”) providers.

The processing system can provide an interface to a cellular network through a defined interface to the cellular network.

The processing system may compute for the aerial antennas:

(i) The beamforming coefficients for the signals received from the UE and BG stations for these phased arrays, normally but not exclusively the coefficients for the antenna elements.

(ii) The phases and amplitudes for the signals to be transmitted to UE and BG stations.

(iii) All algorithms to implement operational aspects such as positional determination of platforms and user equipment.

For any BG stations, the processing system can compute and provide:

(i) The coefficients for the signals to be transmitted by the antenna elements by the BG stations to the aerial antennas.

(ii) The coefficients for the signals received from the BG station antenna elements in the sparse phased array antennas used.

The BG stations can be linked directly to a processing centre via high-speed connections such as fibre optic data links or direct microwave links.

Optimisation of Positions of SHHAPs

In general, a service area will be provided with a fixed number of SHHAPs determined by some economic, technical and/or regulatory constraints.

It is an object of the present invention to provide positions of members of the fleet of SHHAPs by means of an optimising function which relates usually to an economic assessment of the system to provide a particular service function. Examples of service function can be to
(a) Provide a certain minimum level of service (defined by Mbps per user equipment in transmit or receive mode or a combination) to a given proportion of the population or given fraction of particular types of UE if equipped with suitable user equipment.
(b) Provide an average level of service to a given proportion of the population or given fraction of particular types of UE if equipped with suitable user equipment.
(c) Provide certain levels of service to different subsets of UE in the service area, the sets being defined by some or more of the following: type of UE, location, time of day, date, and so forth.
(d) Some combinations of the above.

The optimising function used should take into account the operational and capital expenditure of the SHHAPs and associated equipment including backhaul ground stations and software costs, as well as the degree of availability required, for example, 60%, 95%, 99%, 99.9%, 99.99% and so forth.

The analysis below teaches that for high population density areas it may be desirable to operate SHHAPs at spacings as low as 0.2× the SHHAPs altitude (2 km radius for each individual SHHAP). However, at these small illuminated areas movement of SHHAPs when station holding can become significant.

For beamforming by user equipment using one or more phased arrays to communicate with multiple SHHAPs simultaneously to improve data transmission rates to and from the user equipment by allowing spatial resolution of individual SHHAPs from the user equipment when there are at least 4 SHHAPs in line of sight.

The invention will now be illustrated, by way of example, and with reference to the following figures, in which:

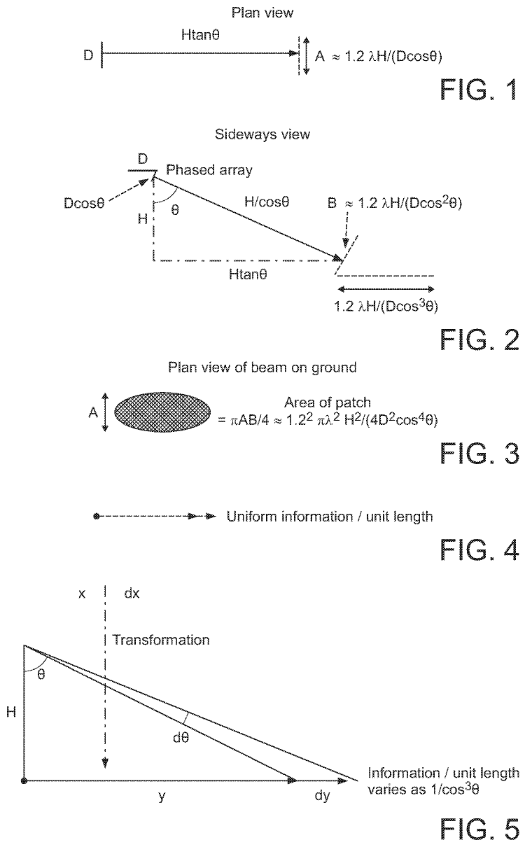

FIG. 1 is a plan view representation of a phased array antenna and how the patch size varies with lateral distance in one dimension.

FIG. 2 is a side view representation of a phased array antenna and how the patch size varies with lateral distance in one dimension.

FIG. 3 is a plan view representation of how the patch size varies with lateral distance in two dimensions.

FIG. 4 shows a radial length where the data rate is constant per unit length.

FIG. 5 shows the radial length of FIG. 3 transformed where the data rate varies as 1/cos³θ.

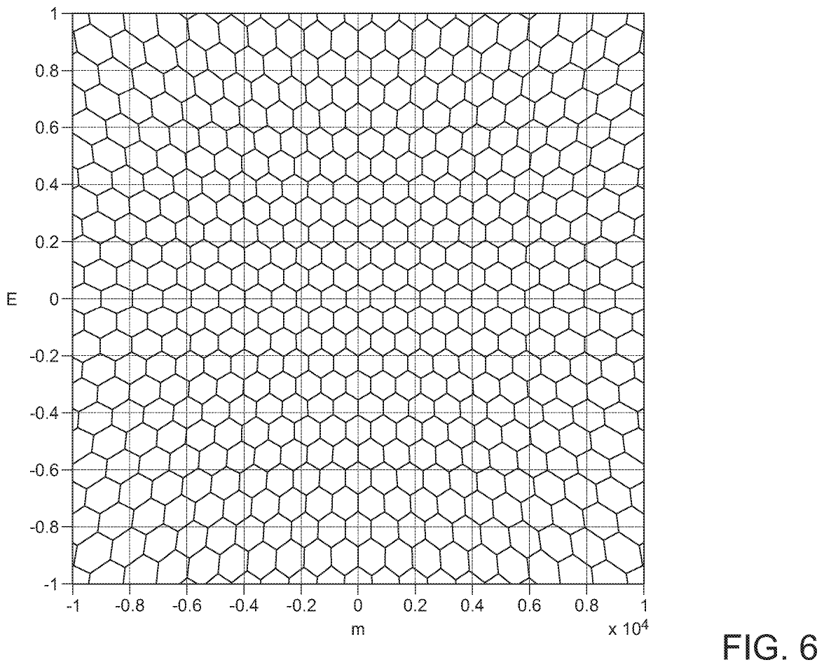

FIG. 6 is a schematic representation of patch geometries on a notional flat ground surface, provided by an aerial antenna centrally located.

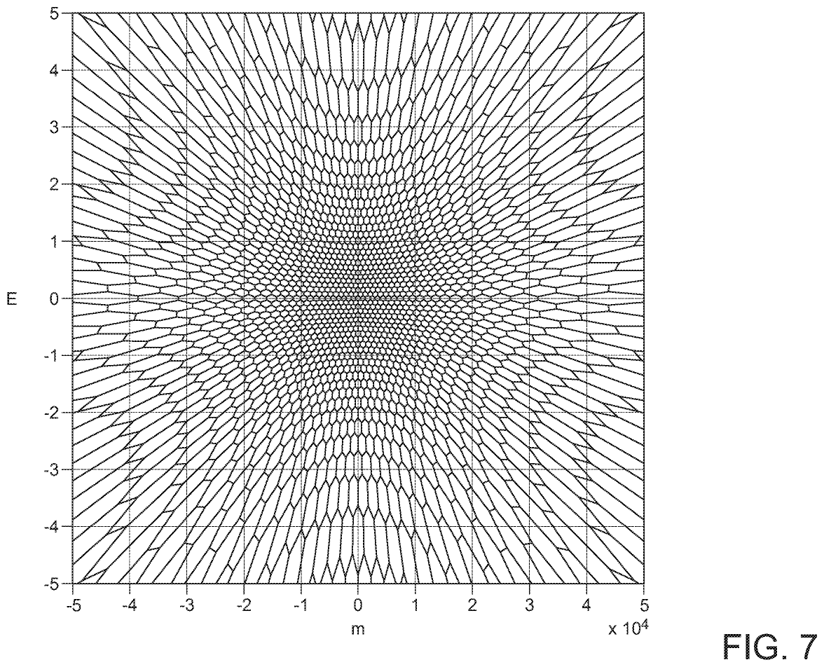

FIG. 7 is a schematic representation of patch geometries on a notional flat ground surface, provided by an aerial antenna centrally located.

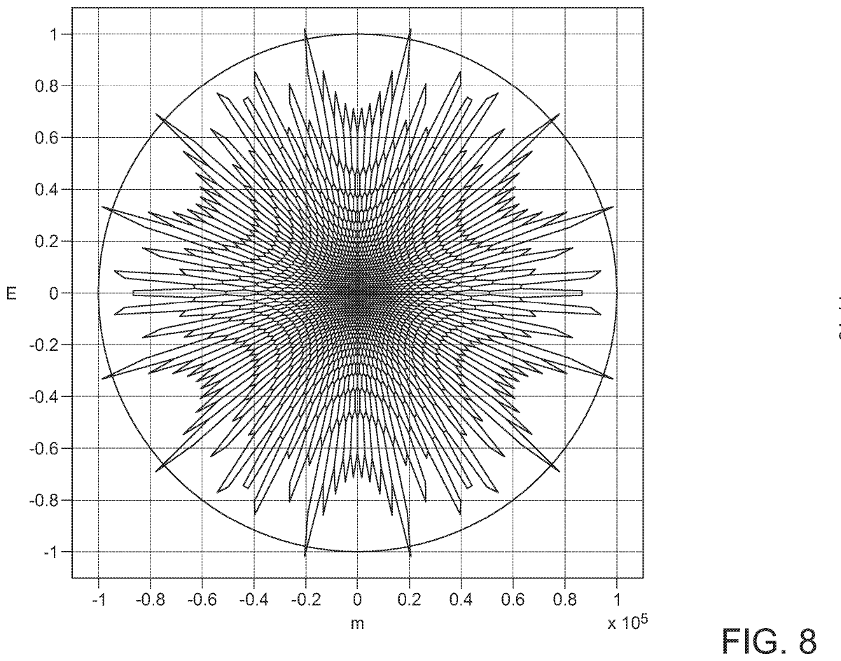

FIG. 8 is a schematic representation of patch geometries on a notional flat ground surface, provided by an aerial antenna centrally located.

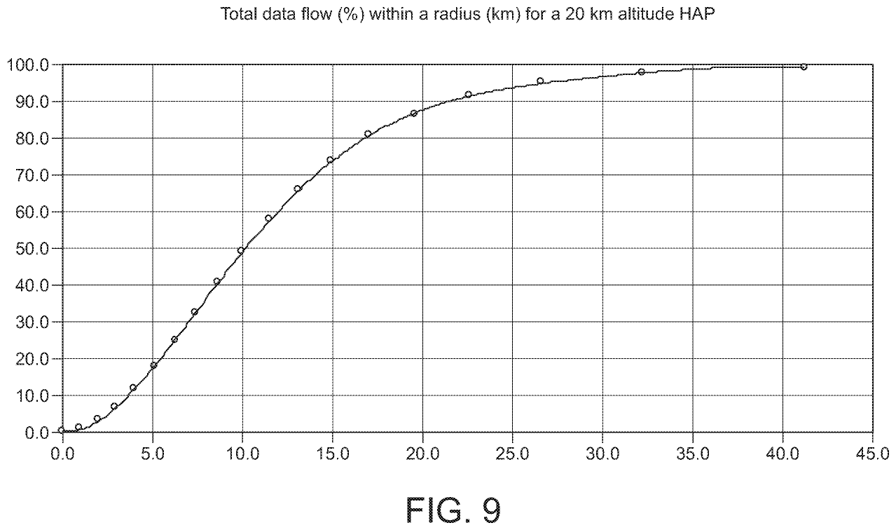

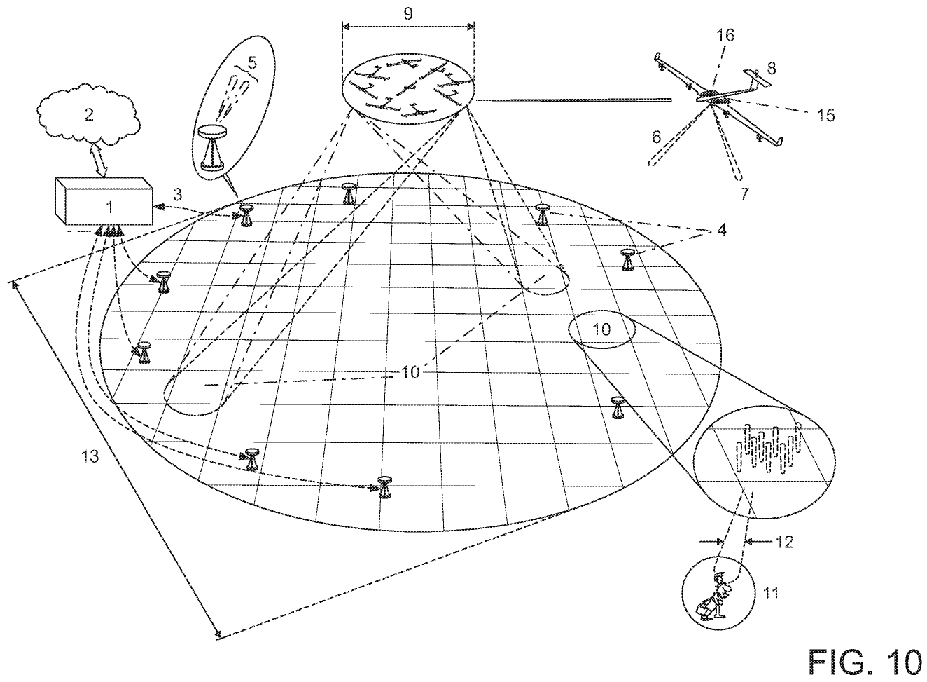

FIG. 9 is a chart showing the percentage reduction of maximum date rate as a function of lateral distance away from being directly underneath an aerial antenna.

FIG. 10 is a schematic representation of a fleet of SHHAPs providing information services over a service area.

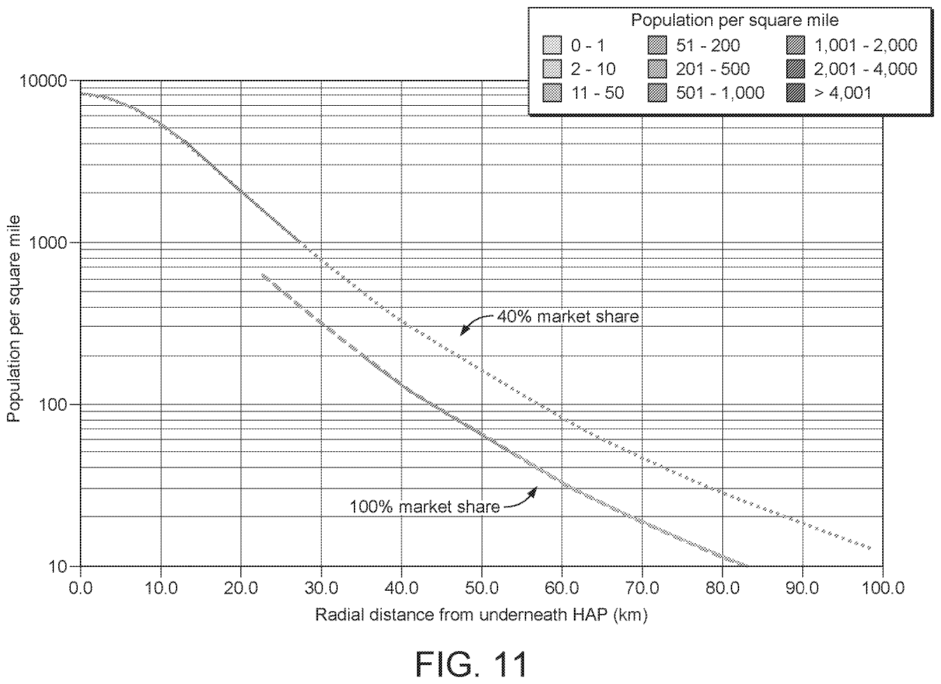

FIG. 11 is a chart showing the population per square mile that can be provided as a function of radial distance from underneath a SHHAP.

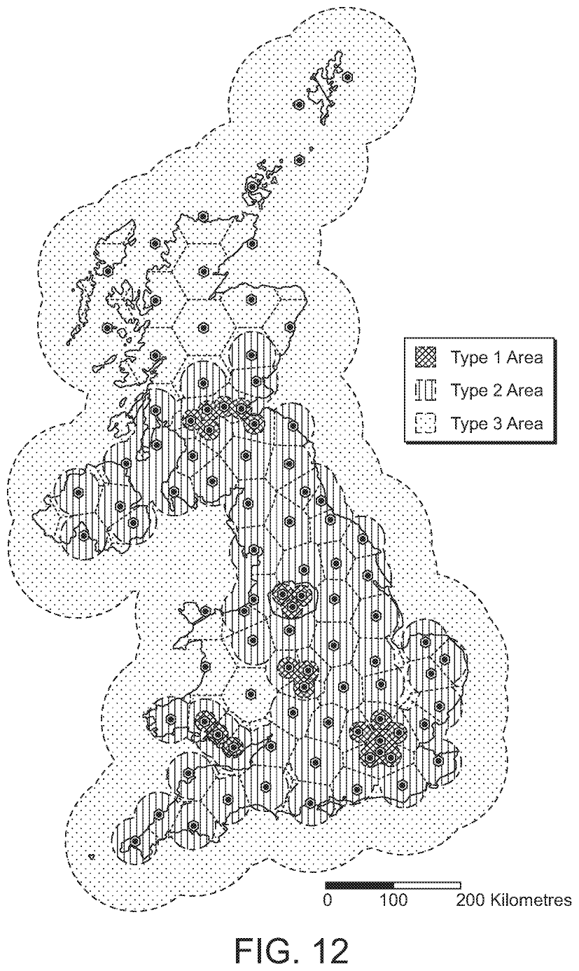

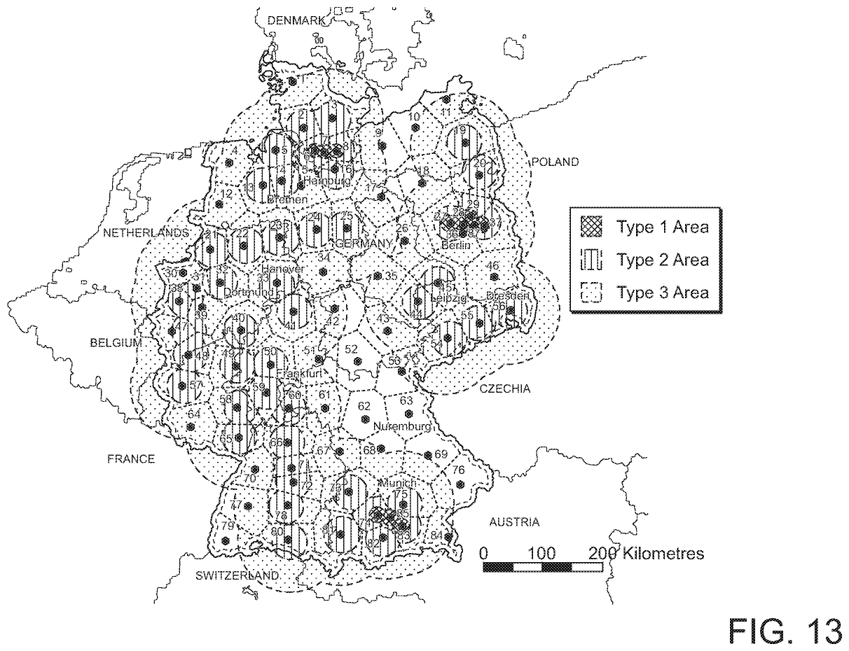

FIG. 12 is a map of the United Kingdom, showing the location of SHHAPs that have been optimally positioned according to the present invention.

FIG. 13 is a map of Germany, showing the location of SHHAPs that have been optimally positioned according to the present invention.

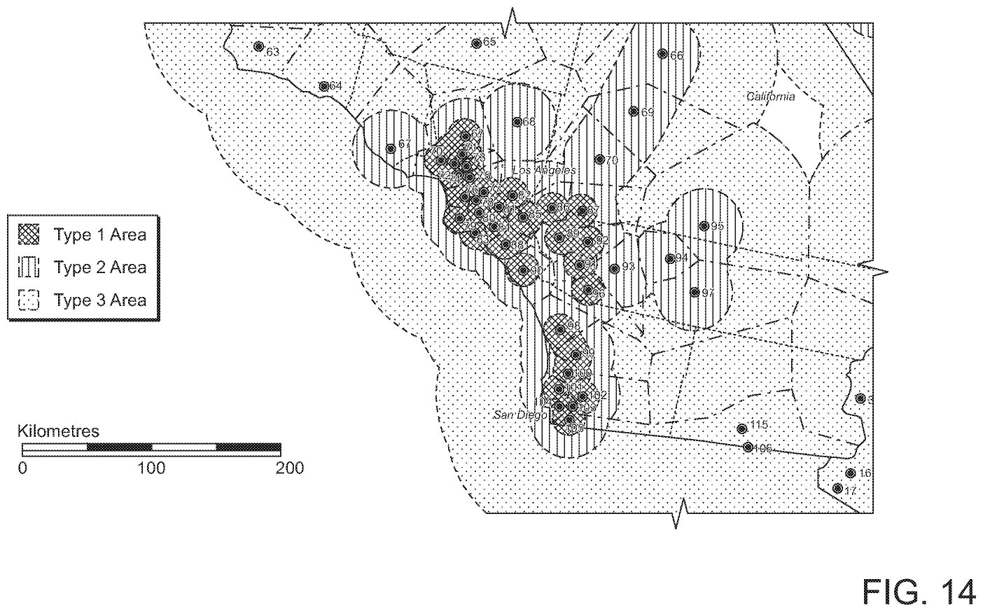

FIG. 14 is a map of part of California, showing the location of SHHAPs that have been optimally positioned according to the present invention.

Underpinning Theory

If the antenna on the aircraft can be approximated to a flat circular phased array, then the beam diameter in an azimuthal direction will not change and be approximately proportional to the distance from the aircraft×1.2× wavelength/array diameter normal to the direction of the beam (the Rayleigh limit) as is well known to those skilled in the art. The distance from the aircraft to the point where the centre of the beam intersects the ground is the height of the aircraft divided by the cosine of the vertical elevation angle θ (the horizontal distance being Htanθ) or 1.2λH/(Dcosθ) (see FIG. 1 and FIG. 2).

By a geometrical analysis, the equivalent beam diameter normal to the axis of the beam in a vertical plane will be approximately proportional to the distance from the aircraft×1.2× wavelength/the array diameter projected onto a surface at right angles to the axis of the beam in the vertical plane. This projected array diameter will be smaller than the diameter of the array by a factor cos θ (see FIG. 2) and the beam width in this direction B will be 1.2λH/(Dcos²θ).

On the ground, this will project to a larger length (as shown in FIG. 2), of 1.2λH/(Dcos³θ).

As a result, the beam on the ground (see FIG. 3) will approximate to an ellipse with an area of 1.2² πλ²H²/(D² cos⁴θ).

Whilst the above analysis is only approximate since the Rayleigh limit varies by more than suggested above at large angles θ, it gives an indication that the beam area varies primarily as cos⁴θ. Thus the data rate per unit area, with a constant data rate per beam, will be approximately inversely proportional to the minimum beam area and therefore proportional to 1/cos⁴θ. Clearly other factors such as the impact on link budget of increasing distance or the impact of more numerous structural shadowing with low horizontal elevation angles (90-θ), and the earth's curvature will have a secondary or tertiary effect.

An impression of the significant impact of this phenomenon can be described by considering how a uniform data rate per unit area surface is transformed into one where the data rate per unit area is inversely proportional to 1/cos⁴θ.

Carrying out this transformation will involve a circumferential data rate variation of 1/cosθ and a radial data rate variation of 1/cos³θ and the product will give the desired result of a transformation that results in a data rate per unit area of 1/cos⁴θ.

For information per unit length to vary as 1/cos³δ then dy=dx/cos³θ=dx/[H/√(H²+y²)]³ (see FIGS. 4 and 5).

$$x = {\int }_{0}^{y} \frac{dy}{{( 1 + {y}^{2} / {H}^{2} )}^{3 / 2}} ,$$

Therefore,

$$x = {\int }_{0}^{ϕ} \frac{H {sec}^{2} ϕ d ϕ}{{sec}^{3} ϕ}$$

then putting y=H tanϕ; so, dy=Hsec²ϕdϕ, so,

Then,

$$x = {\int }_{0}^{{tan}^{- 1} ( \frac{y}{H} )} \frac{H {sec}^{2} ϕ d ϕ}{{sec}^{3} ϕ} = {\int }_{0}^{{tan}^{- 1} ( \frac{y}{H} )} H cos ϕ d ϕ = {\int }_{0}^{{tan}^{- 1} ( \frac{y}{H} )} H cos ϕ d ϕ = {H [ sin ϕ ]}_{0}^{{tan}^{- 1} ( \frac{y}{H} )}$$

So, x=H sin(tan⁻¹(y/H)), and y=H tan(sin⁻¹(x/H)).

For an aircraft at 20 km altitude, with a beam at 2 GHz, and therefore a wavelength of 15 cm, and a phased array of aperture 3.6 m diameter, immediately beneath the aircraft the beam diameter on the ground is given by 1.2 λH/D=1.2×0.15 m×20 km/3.6 m=1 km. This is the approximate dimension below which two mobile phones or items of user equipment cannot be resolved separately by the phased array.

Approximate beam shapes have been developed for such a circular flat antenna obtained by distorting a uniform array of hexagons with a hexagon diameter of 1 km, distorted according to the radial transformation such that the transformed coordinate radius of a point is equal to H tan(sin⁻¹ (Original Radius/H)), where H (the height of the aircraft)=20 km and the angle from the origin (directly underneath the aircraft) is kept constant.

FIG. 6 shows the central area of 20 km×20 km, FIG. 7 100 km×100 km and FIG. 8 200 km×200 km. The diagram does not take into account topological features of the surface of the earth such as the curvature of the earth which will make the distortion slightly greater at large distances from the aircraft. Each polygon describes an area in which two items of user equipment cannot be resolved from one another, which can usefully be termed a “cell”.

As can be seen from these figures there is a very considerable variation in beam shape at different distances from the aircraft and the shape of the beams are not uniform at different azimuthal angles. For different sized arrays operating at different frequencies the size of the individual patches or cells will scale but the general pattern is set by the geometry of the array (circular, square, rectangular and so forth), and the altitude of the array above ground.

An indication of the total data rate as a function of distance r, from the position immediately underneath the aircraft has been developed from the previous theory.

The data rate in a given area (bps)=l₀ cos⁴θ dA where dA is the area at an angle θ (see FIG. 2), and l₀ is the maximum data rate per unit area that the antenna can handle immediately beneath the aircraft.

For a circular element, dA=2πrdr where r, the radius=Hsinθ and dr=Hcosθdθ, where θ=tan⁻¹ (y/H)

Therefore dl=l₀ cos⁴θ dA=l₀ cos⁴·2πHsinθHcosθdθ

Therefore, the total data rate inside a subtended angle 2θ=2πH² l₀∫₀^{θ}sinθcos⁵θdθ=(1/3) πH² I₀ (1−cos⁶ tan⁻¹(y/H))

This function is shown in FIG. 9.

It should be noted that half the proportion of the maximum phased array data rate that can be transmitted or received takes place within a 10-km distance of the position underneath the aircraft and almost three quarters within 15 km distance and over 95% within 25 km of the aircraft. This result is independent of the array diameter and purely dependent on the altitude of the array.

Example Algorithms to Enable Implementation

The main algorithm described below, the SHHAP Placement Algorithm, is responsible for placing the SHHAPs and tessellating their coverage areas in order to satisfy data density requirements over the service area. It exploits the concept of different data density banded areas arising as a result of the cos⁴θ relationship of data density versus radius from the sub-platform point. The algorithm can operate in areas with high, medium and low data density described previously, giving rise, to for example, 3 bands per SHHAP, or with a higher or lower number of bands as desired—each band forms a concentric ring from the point underneath the SHHAP and gives rise to different patterns of SHHAP coverage area tessellation. Thus, in the earlier example, with areas of high data density, the SHHAPs are located closer together to exploit the highest data density band on each SHHAP, whereas the low data density area places SHHAPs further apart, enabling all 3 data density bands on each SHHAP to be exploited. Thus, the three patterns of SHHAP coverage area tessellation described earlier are obtained.

The SHHAP Placement Algorithm allows for a one-off placement of the SHHAP fleet to cover the service area or can be run periodically to take account of changes in active user equipment density or changes to population demographics. The frequency of operation will depend on the rate of change of these parameters and the desirability to match coverage and capacity density with requirements.

The SHHAP Placement Algorithm will result in potentially overlapping SHHAP coverage areas over part of the service area. This will allow for MIMO techniques to be exploited when users have more than one antenna, thereby increasing the capacity density in the overlapped area. For those areas where overlap is not required, the Service Area Illumination Algorithm below can be executed, which activates beams to limit overlap following each run of the SHHAP placement algorithm.

Definition of Symbols Used in the Algorithms

A is the number of data density bands, where each band has a defined data density range determined by the data rate per beam and the beam diameter on the ground.

HDᵢ is the SHHAP coverage area associated with data density band i.

C is the set of clusters corresponding to all A data densities.

Cᵢ is the set of clusters which correspond to the user equipment density associated with data density band i.

C_{i,j} is a specific cluster j in the set of clusters Cᵢ.

B is the number of clusters within the set Cᵢ.

SHHAP Placement Algorithm

Step 1: Divide each SHHAP coverage area into A bands of different data density (HDᵢ), ordered from the highest data density to lowest, where i is in the range 1 to A, such that i=1 represents the highest data density band area and i=A represents the lowest data density band area.

Step 2: Use a density-based clustering algorithm on population demographics/active user location data to identify the location of cluster centroids and their corresponding area, using the same A data density bands, such that each band contains as a set of clusters corresponding to that density range.

Step 3: Arrange the set of clusters Cᵢ in order of decreasing data density, where i is in the range 1 to A, such that i=1 represents the set of clusters corresponding to the highest data density and i=A represents the set of clusters with the lowest data density.

```
Step 4: For i = 1 to A
    Order the clusters in set Cᵢ in order of decreasing area.
    For j = 1 to B
      If area of C_{i,j} is not covered with a SHHAP with data density areas
  HD_{(i∈1..i)}
        Place SHHAP sub-platform point on C_{i,j} centroid.
        If area of C_{i,j} extends beyond the areas of HD_{(i∈1..i)} of the placed
        SHHAP
          Place the minimum number of additional SHHAPs to
        cover area C_{i,j}, rearranging all, including the first, to maximise
        tessellation and coverage over the area of cluster C_{i,j}, using the
        coverage areas HD_{(i∈1..i)} of each of the SHHAPs.
        End
      End
    End
  End
```

Step 5: Repeat algorithm periodically to take account of changes in population demographics/active user locations, number of SHHAPs available.

Service Area Illumination Algorithm to maximise Non-Overlapping Coverage from the SHHAP fleet (if required)

After each run of the SHHAP Placement Algorithm

```
While Service Area is not illuminated
  i=1
  Activate all beams on SHHAPs in area HDᵢ that have minimal
overlapping coverage (to within a desired percentage limit) with an
existing activated beam
  (beams can be selected randomly from different SHHAPs within
the same HDᵢ to even out load, while ensuring no overlap occurs)
  i=i+1
End
```

### EXAMPLES

FIG. 10 is a schematic representation of a fleet of SHHAPs operating above a 60 km diameter region of high data rate requirement (13) (e.g. a pattern one region) within a larger service area utilizing multiple SHHAPs (8) to create a fleet of antennas. As shown, each aircraft platform (8) supports two antennas (15,16), one used for transmission and one for reception. These systems can provide many separate beams (6,7) in different directions to communicate with UEs (11) situated on different “patches” (10), areas illuminated by an antenna beam, and can also provide the “backhaul” links (5) to the “backhaul ground”, BG stations (4). The UE shown in this case is a mobile phone but could be an antenna placed on the side of a house, on top of a vehicle, on an aircraft, ship, train, or inside a building.

This embodiment can provide communication links with BG stations (4) to provide the backhaul data communication systems that support the UE activities with the rest of the cellular network. The BG stations can be connected to the ground-based computer processing centres (1) via standard protocols; by fibre optic, or microwave connections or any other physical connection technology (3). For simplicity, not all the links to the BG stations are shown in FIG. 10.

Data Rate Calculation

Consider an aircraft at an altitude of 20 km, with a single circular phased array antenna for front haul to ground based user equipment, with a diameter of 3.6 m operating at 2 GHz with a bandwidth of 100 MHz, with sufficient power to provide 3 bits per second/Hz with two polarizations and approximately 1750 elements of 0.075 m square area.

This provides a maximum data rate per beam of 100 MHz×3 bps/Hz× two polarisations=600 Mbps/beam.

Immediately underneath the aircraft the beam diameter=1.2× (wavelength/diameter)× altitude=1.2× (0.15 m/3.6 m)×20 km=1 km.

So the maximum data rate down to UE on the ground for each polarisation is 300 Mbps/(area of a 1 km diameter circle)=382 Mbps/km2.

With both polarisations, the maximum data rate from a single aircraft is twice this— 764 Mbps/km2.

At a distance from the point underneath each SHHAP, the maximum data rate will be given—assuming power to the beams is appropriately adjusted to make up for link budget effects on the numbers of bits/second per hertz and that the distances are sufficiently small to make corrections for the earth's curvature, by 764 cos⁴θ Mbps/Hz where θ is the angle of incidence of the beam to the antenna and is given by θ=arc tan(r/H) where r (the radius) is the distance of the UE from a point on the ground directly underneath the aircraft and H is the altitude of the aircraft. For example at 10 km radius, the angle θ is arc tan(10/20)=26.6 degrees, and the maximum data rate=764 cos⁴ (26.6) bps/km2=489 Mbps/km2.

Current mobile phone monthly data demand rate is around 8 GBytes/month in the US and somewhat lower on average in for example, Europe. For a demand of 8 GB/month, the average instantaneous data demand rate varies depending particularly on the time of day, with a local area having at peak times of day twice this data rate that is equivalent to a rate of 50 kbps per UE currently. Taking average user demand of 100 Gbytes/month at some time in the next decade, when a SHHAPs system might be deployed, provides an average peak user demand of 600 kbps per UE, or 0.6 Mbps per UE.

If the aircraft is providing a service to 40% of the user equipment, then at a 10 km radius from the aircraft the maximum number of users that can be satisfied with this average data rate=489 Mbps/km2/(0.4×0.6) Mbps=2040 UE/km2.

The equivalent figure for areas expressed in square miles is 2.59×2040=5280 per square mile.

It can be expected that in densely populated areas other technologies will be more effective than in suburban and rural areas. In that context the distribution of data capability with radius r may be modified to assume, for example, that at a particular population density the market share starts to increase from 40% to 100%. Such a curve is shown in FIG. 11.

This process is an example of part of an optimisation process for identifying where to place aircraft to provide optimal data rates.

For the data demand suggested in the centres of conurbations a single aircraft would not be able to provide for the data demands projected at 40% market share.

However, by allowing close placement of SHHAPS, the curve can be modified, so that, for example, when three or four SHHAPS are visible and resolvable by a UE, much greater data demand rates can be satisfied. With short link budgets, almost directly beneath the aircraft the bps/Hz rates can also be increased.

However, the impact of population distributions and the physics of phased array antennas provide for the striking difference in patterns over dense conurbations, rural and sparsely populated areas as shown in the example of the United Kingdom in FIG. 12, Germany in FIG. 13, and California in FIG. 14. It can be seen that the coverage areas produced are not all circular, due to overlap. The coverage areas also vary in area inversely correlated to the data demand.

As can be seen, the locations of the SHHAPs track the areas of highest population density, but also take into account the drop off in data rate provision provided by the algorithm in order to provide a very good service level for the entirety of the service area.

1. A fleet of station holding high altitude platforms (SHHAPs) arranged to provide information services to a service area, each SHHAP comprising at least one phased array antenna and in communication with a telecommunications backhaul system, the service area comprising at least 100,000 items of user equipment (UE), and wherein the service area comprises a non-uniform data requirement distribution, comprising regions of both higher and lower data rate requirements, and wherein the SHHAPs are positioned with a non-uniform spacing such that the SHHAPs are positioned closer together over the regions of higher data rate requirements than over the regions of lower data rate requirements.

2. The fleet according to claim 1, wherein the service area comprises greater than 200,000 items of UE.

3. The fleet according to claim 1, wherein the service area is greater than 10,000 km².

4. The fleet according to claim 1, wherein the service area includes a plurality of cities.

5. The fleet according to claim 1, which comprises at least 10 SHHAPs.

6. The fleet according to claim 1, wherein the SHHAPs have an altitude of from 10,000 to 25,000 metres.

7. The fleet according to claim 1, wherein the SHHAPs that are located over the regions of higher data rate requirements have a lower altitude than the SHHAPs that are located over the regions of lower data rate requirements.

8. The fleet according to claim 1, wherein the regions of higher data rate requirements contain a higher user equipment density and the regions of lower data rate requirements contain a lower user equipment density, and wherein the ratio of the highest to lowest user equipment density is at least 10.

9. The fleet according to claim 1, wherein the SHHAPs are positioned such that the ratio between the most furthest spaced apart SHHAPs to the most closely spaced apart SHHAPs is at least 2.

10. The fleet according to claim 6, wherein the SHHAPs are aircraft that have minimum cruising airspeeds of at least 20 m/s.

11. The fleet according to claim 1, wherein the SHHAPs are aircraft that are powered using either solar energy or hydrogen or hydrocarbon fuel.

12. The fleet according to claim 1, wherein the SHHAPs are free flying aerostats powered by solar cells or other technologies.

13. The fleet according to claim 1, wherein the SHHAPs are tethered aerostats powered by hydrogen conveyed along tethers, or supplied with electrical power via the tethers or supplied by solar cells situated on or connected to aerostat platforms.

14. The fleet according to claim 1, which includes a first arrangement of SHHAPs (pattern one), where for at least three SHHAPs of the first pattern, the distances between SHHAPs are equal to between p and q times the SHHAP altitude for communication to areas where the population density is greater than 2000 UE per km², wherein p is greater than 0.2 and q is in the range 1 to 2.

15. The fleet according to claim 14, which includes a second arrangement of SHHAPs (pattern two), where for at least three SHHAPs of the second pattern, the distances between SHHAPs are equal to between q and r times the SHHAP altitude for communication to areas where the population density is less than 2000 UE per km², wherein is in the range of 2 to 4.

16. A system for providing information services to a service area, the system comprising the fleet of SHHAPs according to claim 1, in combination with a backhaul ground station arrangement, wherein the ground stations are positioned with a non-uniform spacing such that the ground stations are positioned closer together in the regions of higher data rate requirements than in the regions of lower data rate requirements.

17. A method of positioning members of a fleet of station holding high altitude platforms (SHHAPs) to provide information services to a service area, each SHHAP comprising at least one phased array antenna and in communication with a telecommunications backhaul system, the service area comprising at least 100,000 items of user equipment (UE), and wherein the ratio of the highest to the lowest user equipment density is at least 10, and wherein the method employs a first step of performing an optimising data provision rate calculation involving the parameter cost or approximately equivalent function, where θ is the angle between the vertical and a line drawn between the UE located at ground level and the SHHAP, to provide a data service rate to each UE, followed by a second step of positioning the members of the fleet according to the results of the optimising calculation.

18. The method according to claim 17, which adapts in real time to changes in data requirement distribution in the service area.

19. The method according to claim 17, wherein the number of SHHAPs is fixed and the data provision rate calculation involves the provision of a minimum or average data rate to essentially all UE in the service area.

20. A computer program comprising computer implementable instructions which, when implemented on a computer, causes the computer to perform the method of claim 17.

21. A computer program product comprising the computer program as defined in claim 20.
